(19) United States
(12) Patent Application Publication
(10) Pub. No.: US 2024/0360869 A1
(43) Pub. Date: Oct. 31, 2024

(54) SUSPENSION BEARING UNIT

(71) Applicant: AKTIEBOLAGET SKF, GOTEBORG (SE)

(72) Inventors: Julien MAFFUCCI, Ballan-Miré (FR); Bruno MONTBOEUF, Saint-Cyr-Sur-Loire (FR)

(21) Appl. No.: 18/639,074

(22) Filed: Apr. 18, 2024

(30) Foreign Application Priority Data
Apr. 26, 2023 (FR) 2304207

(51) Int. Cl. F16C 19/16; B60G 13/00; F16C 35/06

(52) U.S. Cl. CPC F16C 19/16; B60G 13/00; F16C 35/06; B60G 2204/41; B60G 2204/418; F16C 2326/05

(57) ABSTRACT

A suspension bearing unit includes a lower support cap, an upper bearing cap, and at least one bearing disposed between the lower support can and the upper bearing caps. The lower support cap and/or the upper bearing cap includes at least one first set of circumferentially spaced recesses on an annular radial portion of the cap that forms a first ring of recesses and at least one second set of circumferentially spaced recesses on the annular radial portion that forms a second ring of recesses. At least portions of the recesses of the second set of recesses are located radially outward of radially outermost portions of the recesses of the first set of recesses.

### CROSS-REFERENCE

This application claims priority to French patent application no. 2304207 filed on Apr. 26, 2023, the contents of which are fully incorporated herein by reference.

### TECHNOLOGICAL FIELD

The present disclosure is directed to the field of suspension bearing units used in particular in the suspension struts of the steered wheels of motor vehicles.

### BACKGROUND

A suspension bearing unit generally comprises an axial thrust bearing and upper and lower caps that form a housing for the rings of the bearing and that provide and interface between the rings and neighboring elements.

The suspension bearing unit is disposed in the upper part of the suspension strut between a suspension spring and the bodyshell of the vehicle. The suspension spring is mounted around a shock-absorber piston rod, the end of which is connected to the bodyshell of the vehicle. The suspension spring, of the helical spring type, bears axially, directly or indirectly, on the lower cap of the suspension bearing unit.

The suspension bearing unit makes it possible to transmit axial and radial loads between the suspension spring and the bodyshell of the vehicle while still allowing a relative rotational movement between the lower cap and the upper cap arising from a turn of the steered wheels of the vehicle and/or from the compression of the suspension spring.

In general, the upper cap of the suspension bearing unit is provided with a plurality of hooks that are disposed on an external skirt and are designed to diametrically engage with a plurality of hooks of the lower cap. The hooks of each cap are spaced from one another in the circumferential direction. The hooks form retaining means for axially retaining the upper and lower caps in relation to one another.

### SUMMARY

An aspect of the present disclosure is to reduce the manufacturing costs for suspension bearing units of the type having a lower support cap, an upper bearing cap, and at least one bearing disposed between the caps.

According to a general feature, at least one of the caps comprises at least one first group of recesses spaced from one another in the circumferential direction on an annular radial portion of the cap so as to form a first ring of recesses, and at least one second group of recesses spaced from one another in the circumferential direction on the annular radial portion so as to form a second ring of recesses.

The recesses of the second group are at least partially offset radially to the outside relative to the recesses of the first group.

The recesses of the first and second groups of recesses make it possible to reduce the amount of material used for manufacturing the suspension bearing unit, and thus to reduce the manufacturing cost.

Advantageously, the first and second groups of recesses leave an inner solid annular radial portion and an outer solid annular radial portion remaining on the radial portion of the cap, the inner and outer solid annular radial portions being situated radially on either side of the first and second groups of recesses.

The inner and outer solid annular radial portions improve the stiffness of the cap.

Optionally, the radial dimension of the inner solid annular radial portion of the radial portion of the cap may be at least twice the radial dimension of the outer solid annular radial portion of the radial portion of the cap.

Advantageously, the recesses of the first and second groups of recesses leave circumferentially alternating first and second webs of material, each extending radially between the inner solid annular radial portion and the outer solid annular radial portion, remaining on the radial portion of the cap.

The forces applied to the suspension bearing unit are predominantly applied obliquely from the upper bearing cap to the lower support cap and radially outwards. The first and second webs of material further improve the stiffness of the cap, notably by distributing the forces applied to the suspension bearing unit.

Optionally, the first and second webs of material extend purely radially between the inner solid annular radial portion and the outer solid annular radial portion.

Advantageously, the recesses of the first and second groups of recesses leave third webs of material, each extending from the proximal end of one of the second webs to the distal end of one of the first webs directly adjacent to the second web in the circumferential direction, remaining on the radial portion of the cap.

The third webs of material also make it possible to distribute the forces applied to the suspension bearing unit and further improve the stiffness of the cap. As a result, the mechanical strength of the suspension bearing is increased.

Optionally, each of the webs of material has a constant cross section.

Advantageously, the recesses of the first and second groups of recesses are arranged on the radial portion of the cap such that a recess of the first group of recesses and a recess of the second group of recesses are arranged between each of the first and second webs directly following one another in the circumferential direction.

Advantageously, the first and second groups of recesses comprise triangular recesses.

“Triangular recess” is understood to mean a recess forming, on the surface of the cap, a shape with three sides, each of the three sides being respectively straight or curved in a circumferential direction.

Advantageously, the dimensions of the recesses of the second group of recesses are greater than the dimensions of the recesses of the first group of recesses.

As a result, the surface of the cap is recessed to a greater extent in an area subjected to fewer forces.

Optionally, the recesses of the first group of recesses are arranged on the radial portion of the cap so as to form a first circumferentially regularly repeated pattern, the recesses of the second group of recesses being arranged on the radial portion of the cap so as to form a second circumferentially regularly repeated pattern.

The first and second circumferentially regularly repeated patterns confer at least one symmetry on the recesses of the annular radial portion of the cap.

Advantageously, the suspension bearing unit also comprises a shock-absorbing element which is made of elastic material, is overmolded on the cap and extends into the recesses of the first and second groups of recesses.

The recesses of the first and second groups of recesses improve the engagement of the shock-absorbing element.

Another aspect of the disclosure comprises a suspension bearing unit that includes a lower support cap, an upper bearing cap, and at least one bearing disposed between the lower support can and the upper bearing caps. The lower support cap and/or the upper bearing cap includes at least one first set of circumferentially spaced recesses on an annular radial portion of the cap that forms a first ring of recesses, and at least one second set of circumferentially spaced recesses on the annular radial portion forming a second ring of recesses, and at least portions of the recesses of the second set of recesses are located radially outward of radially outermost portions of the recesses of the first set of recesses. Furthermore, the annular radial portion includes a radially outer circumferential edge and a radially inner circumferential edge, and the first set of recesses is spaced radially outward from the radially inner circumferential edge and the second set of recesses is spaced radially inward from the radially outer circumferential edge. The recesses of the first and second sets of recesses may be arranged such that a plurality of uninterrupted radial webs extend from the radially inner circumferential edge to the radially outer circumferential edge. Furthermore, the recesses of the first set of recesses may be separated from the recesses of the second set of recesses by non-radial webs of material, each of which extends from a first one of the radial webs to a second one of the radial webs.

### BRIEF DESCRIPTION OF THE DRAWINGS

The present invention will be better understood on studying the detailed description of embodiments, given by way of non-limiting example and illustrated by the appended drawings, in which:

FIG. 1 is an axial sectional view of a suspension bearing unit according to a first exemplary embodiment of the invention.

FIG. 2 is a bottom plan view, partly in section, of the unit of FIG. 1.

FIG. 3 is a detail view of a portion of FIG. 2.

FIG. 4 is an axial sectional view of a suspension bearing unit according to a second exemplary embodiment of the invention.

FIG. 5 is a detail view of a portion of suspension bearing unit according to a third exemplary embodiment of the invention.

### DETAILED DESCRIPTION

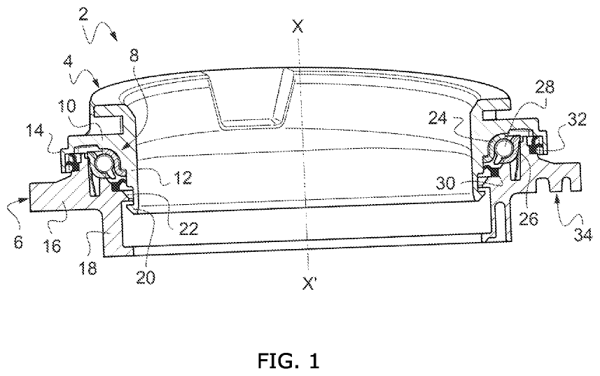

The suspension bearing unit 2 shown in FIG. 1 is suitable for installation between a cup or upper bearing seat configured to contact a fixed chassis element of a motor vehicle and a helical suspension spring. In FIG. 1, the suspension bearing unit 2 is shown in an assumed vertical position.

The suspension bearing unit 2, of axis X-X′, comprises an upper bearing cap 4, a lower support cap 6, and a rolling bearing 8 interposed axially between the upper and lower bearing caps 4, 6.

In the example illustrated, the upper bearing cap 4 and the lower support cap 6 are mounted in direct contact with the bearing 8 without an interposed intermediate element. In a variant, the upper bearing cap 4 and the lower support cap 6 may be mounted in indirect contact with the bearing 8 with an interposed intermediate element.

The upper bearing cap 4 in this case is formed as a single piece, for example made of a plastic material, for example such as polyamide (PA) 6.6, which may optionally be reinforced with glass fibers.

The upper bearing cap 4, of axis X-X′, comprises a radial portion 10, an annular axial internal skirt 12, and an annular axial external skirt 14 radially surrounding the internal skirt 12.

The radial portion 10 of the upper bearing cap 4 has an upper surface (not provided with a reference sign) intended to face the upper bearing seat and an opposite lower surface (not provided with a reference sign) that contacts the bearing 8. The upper and lower surfaces define the thickness of the radial portion 10 of the upper bearing cap 4. In the example illustrated, the radial portion 10 of the upper bearing cap 4 has a stepped form.

In the example illustrated, the upper surface of the radial portion 10 of the upper bearing cap 4 is inclined. In a variant, the upper surface of the radial portion 10 of the upper bearing cap 4 may be purely radial.

The external skirt 14 of the upper bearing cap 4 extends axially from the radial portion 10 of the upper bearing cap 4 and surrounds a portion of the lower support cap 6. In the example illustrated, the external skirt 14 of the upper bearing cap 4 extends from a large-diameter edge of the radial portion 10 of the upper bearing cap 4.

The internal skirt 12 of the upper bearing cap 4 extends inside the bore of the lower support cap 6. The internal and external skirts 12, 14 of the upper bearing cap 4 extend axially downwards from the radial portion 10 of the upper bearing cap 4. The internal skirt 12 extends from a small-diameter edge of the radial portion 10 of the upper bearing cap 4.

“Axially downwards” is understood to mean the axial direction from the upper bearing cap 4 to the lower support cap 6.

The lower support cap 6, of axis X-X′, comprises an annular radial portion 16 in the form of a plate and a cylindrical axial skirt 18 extending from a small-diameter edge of the radial portion 16 of the lower support cap 6.

The skirt 18 of the lower support cap 6 extends axially away from the upper bearing cap 4 and the bearing 8. The skirt 18 of the lower support cap 6 makes it possible to center the suspension spring.

The upper bearing cap 4 comprises a plurality of internal hooks 20 that are disposed on the internal skirt 12 of the upper bearing cap 4 and that extend radially outwards toward the lower support cap 6. In the example illustrated, the hooks 20 are spaced from one another in the circumferential direction. In a variant, it could be possible to provide a single annular hook (or flange) 20.

The lower support cap 6 comprises a plurality of internal hooks 22 that are disposed on the radial portion 16 of the lower support cap 6 and extend radially inwards toward the upper bearing cap 4, the plurality of internal hooks 22 being designed to diametrically engage with the plurality of internal hooks 20 of the upper bearing cap 4. In a variant, it could be possible to provide a single annular hook (or flange) 22.

The hooks 20, 22 form retaining means for axially retaining the upper bearing cap 4 and lower support cap 6 in relation to one another.

The bearing 8 is situated entirely radially between the skirts 12, 14 of the upper bearing cap 4. The bearing 8 comprises an upper ring 24 in contact with the upper bearing cap 4, a lower ring 26 in contact with the lower support cap 6, and a row of rolling elements 28, in this case balls, disposed between the raceways formed on the rings 24, 26. In the example illustrated, the rolling bearing is of the angular contact type. The upper ring 24 is in contact with the lower surface of the radial portion 10 of the upper bearing cap 4. The lower ring 26 is in contact with an upper surface of the lower support cap 6, the upper surface having a complementary shape to the lower ring 26 of the bearing 8.

The lower support cap 6 in this case is a body formed in a single piece, for example made of plastics material, for example such as polyamide (PA) 6.6, which may optionally be reinforced with glass fibers.

The suspension bearing unit 2 comprises an internal seal 30 which is fixed to the lower support cap 6 and interacts by way of contact with the internal skirt 12 of the upper bearing cap 4.

The suspension bearing unit 2 also comprises an external seal 32 which is fixed to the lower support cap 6 and interacts by way of contact with the external skirt 14 of the upper bearing cap 4.

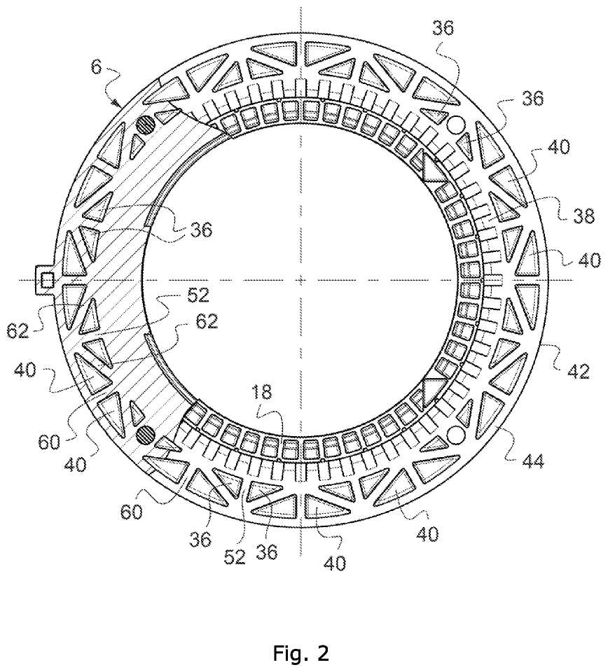

As illustrated more clearly in FIG. 2, the radial portion 16 of the lower support cap 6 has a lower annular radial surface 34 delimiting a bearing surface for the suspension spring.

The radial portion 16 of the lower support cap 6 comprises a first group of recesses 36 which are spaced from one another in the circumferential direction and form a first ring of recesses 36 on the bearing surface 34.

Each recess 36 of the first group of recesses is formed at a distance from the skirt 18 of the lower support cap 6 so as to leave an inner solid annular radial portion 38 remaining, the inner solid annular radial portion 38 not having any recesses.

The radial portion 16 of the lower support cap 6 also comprises a second group of recesses 40 which are spaced from one another in the circumferential direction and form a second ring of recesses 40 on the bearing surface 34.

The recesses 40 of the second group of recesses are at least partially offset radially to the outside in relation to the recesses 36 of the first group of recesses.

Each recess 40 of the second group of recesses is formed at a distance from the periphery 42 of the lower support cap 6 so as to leave an outer solid annular radial portion 44 remaining, the outer solid annular radial portion 44 not having any recesses.

The recesses 36, 40 of the first and second groups of recesses are open axially downwards.

The recesses 36, 40 of the first and second groups of recesses do not pass axially through the radial portion 16 of the lower support cap 6.

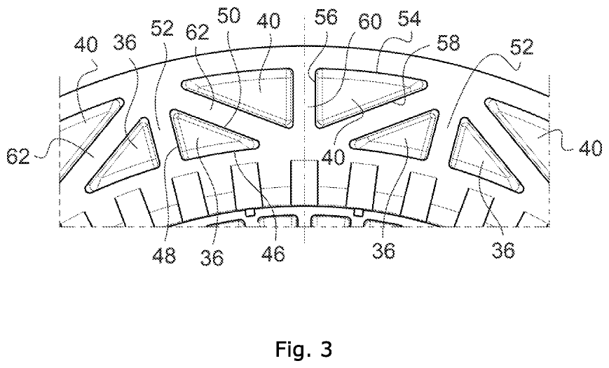

As illustrated more clearly in FIG. 3, the recesses 36 of the first group of recesses are triangular and each has a curved first edge 46, a straight second edge 48 extending purely radially outwards from one end of the curved first edge 46, and a straight third edge 50 rectilinearly joining the first and second edges 46, 48 of the recess 36. The curved first edge 46 of each recess 36 of the first group of recesses is parallel to the periphery 42 of the lower support cap 6, the normal distance between the curved first edge 46 of the recess 36 and the outer periphery 42 of the lower support cap 6 being constant.

The recesses 36 of the first group of recesses are arranged such that the straight second edge 48 of each triangular recess 36 of the first group of recesses faces the straight second edge 48 of another triangular recess 36 of the first group of recesses, the straight second edges 48 being mutually parallel.

The mutually facing straight second edges 48 of two triangular recesses 36 of the first group of recesses leave first webs 52 of material, extending purely radially between the mutually facing straight second edges 48, remaining on the radial portion 16 of the lower support cap 6, the first webs 52 extending purely radially from the inner solid annular radial portion 38 to the outer solid annular radial portion 44.

The recesses 40 of the second group of recesses are triangular, and each includes a curved first edge 54, a straight second edge 56 extending purely radially inwards from one end of the curved first edge 54, and a straight third edge 58 rectilinearly joining the first and second edges 54, 56 of the recess 40. The curved first edge 54 of each recess 40 of the second group of recesses is parallel to the periphery 42 of the lower support cap 6, the normal distance between the curved first edge 54 of the recess 40 and the outer periphery 42 of the lower support cap 6 being constant.

The recesses 40 of the second group of recesses are arranged such that the straight second edge 56 of each triangular recess 40 of the second group of recesses faces the straight second edge 56 of another triangular recess 40 of the second group of recesses, the straight second edges 56 being mutually parallel.

The mutually facing straight second edges 56 of two triangular recesses 40 of the second group of recesses leave second webs 60 of material, extending purely radially between the mutually facing straight second edges 56, remaining on the radial portion 16 of the lower support cap 6, the second webs 60 extending purely radially from the outer solid annular radial portion 44 to the inner solid annular radial portion 38.

The recesses 36 of the first group of recesses also leave the second webs 60 of material remaining on the radial portion 16 of the lower support cap 6.

The recesses 40 of the second group of recesses also leave the first webs 52 of material remaining on the radial portion 16 of the lower support cap 6.

The recesses 36, 40 of the first and second groups of recesses leave a circumferential succession of first and second webs 52, 60 of material remaining on the radial portion 16 of the lower support cap 6, the succession being composed of circumferentially alternating first webs 52 of material and second webs 60 of material.

A recess 36 of the first group of recesses and a recess 40 of the second group of recesses are situated circumferentially between each first and second web 52, 60 of material that are directly adjacent in the circumferential direction.

The recesses 36, 40 of the first and second groups of recesses are arranged such that the straight third edge 50 of each triangular recess 36 of the first group of recesses faces the straight third edge 58 of a triangular recess 40 of the second group of recesses, the straight third edges 50, 58 being mutually parallel.

The mutually facing straight third edges 50, 58 of a triangular recess 36 of the first group of recesses and a triangular recess 40 of the second group of recesses leave third webs 62 of material remaining on the radial portion 16 of the lower support cap 6. Each third web 62 of material extends from the proximal end of a second web 60 of material to the distal end of a first web 52 of material directly adjacent to the second web 60 of material in the circumferential direction and is joined to the distal end of the first web 52 of material directly adjacent to the second web 60 of material in the circumferential direction.

The proximal end of a second web 60 of material is that end of the second web 60 of material closest to the center of the suspension bearing unit 2.

The distal end of a first web 52 of material is that end of the first web 52 of material furthest away from the center of the suspension bearing unit 2.

The recesses 36, 40 of the first and second groups of recesses leave the third webs 62 of material remaining on the radial portion 16 of the lower support cap 6.

The first group of recesses in this case comprises a number of recesses 36 equal to the number of recesses 40 of the second group of recesses.

The triangular shape of each triangular recess 36 of the first group of recesses has smaller dimensions than the dimensions of the triangular shape of each triangular recess 40 of the second group of recesses.

In a variant, the triangular shape of each triangular recess 40 of the second group of recesses may have smaller dimensions than the dimensions of the triangular shape of each triangular recess 36 of the first group of recesses.

In the example shown, the recesses 36 of the first group of recesses are arranged on the radial portion 16 of the lower support cap 6 so as to form a first pattern composed of six triangular recesses 36, the first pattern being circumferentially regularly repeated four times. In a variant, it is possible to provide another arrangement of the recesses 36 of the first group of recesses, notably an arrangement forming a first pattern composed of a different number of recesses 36.

In the example shown, the recesses 40 of the second group of recesses are arranged on the radial portion 16 of the lower support cap 6 so as to form a second pattern composed of two triangular recesses 40, the second pattern being circumferentially regularly repeated twelve times. In a variant, it is possible to provide another arrangement of the recesses 40 of the second group of recesses, notably an arrangement forming a second pattern composed of a different number of recesses 40.

In the example shown, the first group of recesses comprises two different dimensions of recesses 36. In a variant, the first group of recesses may comprise recesses 36 of identical dimensions or more than two different dimensions of recesses 36.

In the example shown, the second group of recesses comprises recesses 40 of identical dimensions. In a variant, the second group of recesses may comprise multiple dimensions of recesses 40.

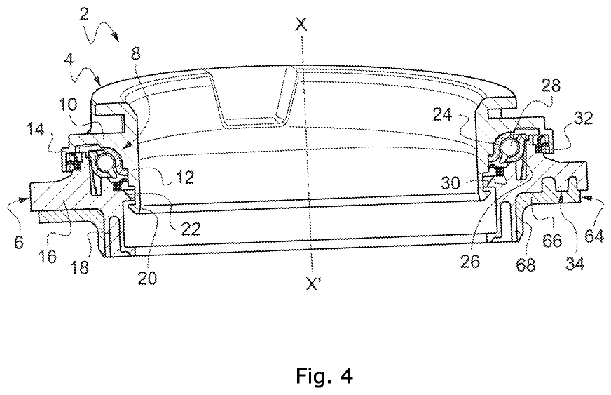

The exemplary embodiment illustrated in FIG. 4, in which elements that are identical bear the same references, differs from the first exemplary embodiment in that the suspension bearing unit 2 comprises a shock-absorbing element 64 overmolded on the lower support cap 6 and made of elastic material in order to damp vibrations, for example made of thermoplastic elastomer rubber (TPE), or thermoplastic polyurethane (TPU), or else cellular elastomer foam.

The shock-absorbing element 64 is overmolded on the bearing surface 34 of the lower support cap 6 and on the radial portion 16 of the lower support cap 6. The shock-absorbing element 64 is also overmolded into the recesses 36, 40 of the first and second groups of recesses.

The shock-absorbing element 64 comprises an annular radial portion 66, and an annular axial skirt 68 extending from a small-diameter edge of the radial portion 66 of the shock-absorbing element 64. The radial portion 66 and the skirt 68 are respectively fixed to the radial portion 16 and the skirt 18 of the lower support cap 6. The skirt 68 of the shock-absorbing element 64 makes it possible to center the suspension spring, and the radial portion 66 of the shock-absorbing element 64 delimits a bearing surface therefor.

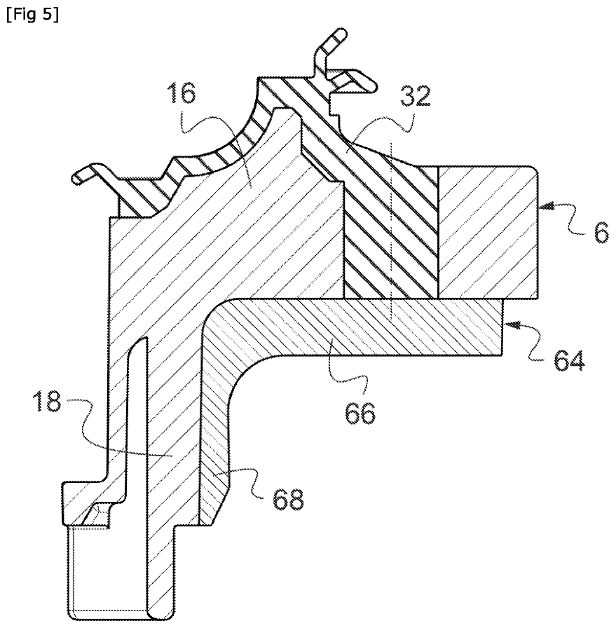

The exemplary embodiment illustrated in FIG. 5, in which elements that are identical bear the same references, differs from the second exemplary embodiment in that the recesses 36, 40 of the first and second groups of recesses pass axially through the radial portion 16 of the lower support cap 6, the recesses 36, 40 of the first and second groups of recesses being open axially downwards and upwards.

The shock-absorbing element 64 is fixed to the lower support cap 6 by overmolding, but is not overmolded in the recesses 36, 40 of the first and second groups of recesses. In a variant, the shock-absorbing element 64 may be fixed to the lower support cap 6 by any suitable means, for example by adhesive bonding.

The external seal 32 of the suspension bearing unit 2 in this case is overmolded in the recesses 36, 40 of the first and second groups of recesses.

In the exemplary embodiments illustrated, the first, second and third webs 52, 60, 62 of material each have a constant cross section between their distal and proximal ends. In a variant, the first, second and third webs 52, 60, 62 of material may have a variable cross section between their distal and proximal ends.

In the exemplary embodiments illustrated, the straight second edge 48 of each recess 36 of the first group of recesses extends purely radially. In a variant, the straight second edge 48 of each recess 36 of the first group of recesses may extend both radially and ortho-radially.

In the exemplary embodiments illustrated, the straight second edge 56 of each recess 40 of the second group of recesses extends purely radially. In a variant, the straight second edge 56 of each recess 40 of the second group of recesses may extend both radially and ortho-radially.

In the exemplary embodiments illustrated, the lower support cap 6 comprises first and second groups of recesses. In a variant, the lower support cap 6 may comprise more than two groups of recesses.

In the exemplary embodiments illustrated, the recesses 36, 40 are formed on the radial portion 16 of the lower support cap 6. In a variant, the recesses 36, 40 may be formed in the radial portion 10 of the upper bearing cap 4.

In the exemplary embodiments illustrated, the suspension bearing unit 2 comprises an angular contact rolling bearing 8 provided with a row of balls. The suspension bearing unit 2 may comprise other types of rolling bearings, for example a bearing of the four-point contact type and/or with at least two rows of balls. The rolling bearing may comprise other types of rolling elements 28, for example rollers. In another variant, the bearing of the suspension bearing unit 2 may comprise a sliding bearing devoid of rolling elements and provided with one or more rings.

What is claimed is:

1. A suspension bearing unit comprising:
a lower support cap,
an upper bearing cap, and
at least one bearing disposed between the lower support can and the upper bearing caps,
wherein the lower support cap and/or the upper bearing cap includes at least one first set of circumferentially spaced recesses on an annular radial portion of the cap forming a first ring of recesses, and at least one second set of circumferentially spaced recesses on the annular radial portion forming a second ring of recesses, and
wherein at least portions of the recesses of the second set of recesses are located radially outward of radially outermost portions of the recesses of the first set of recesses.

2. The suspension bearing unit according to claim 1,
wherein the lower support cap includes the at least one first set of recesses and the at least one second set of recesses.

3. The suspension bearing unit according to claim 2,
wherein the annular radial portion includes a radially outer circumferential edge and a radially inner circumferential edge, and
wherein the first set of recesses is spaced radially outward from the radially inner circumferential edge and the second set of recesses is spaced radially inward from the radially outer circumferential edge.

4. The suspension bearing unit according to claim 3, wherein the recesses of the first and second sets of recesses are arranged such that a plurality of uninterrupted radial webs extend from the radially inner circumferential edge to the radially outer circumferential edge.

5. The suspension bearing unit according to claim 4, wherein the recesses of the first set of recesses are separated from the recesses of the second set of recesses by non-radial webs of material, each of the non-radial webs of material extending from a first one of the radial webs to a second one of the radial webs.

6. The suspension bearing unit according to claim 5, wherein each of the radial webs and the non-radial webs has a constant cross-section.

7. The suspension bearing unit according to claim 5,
wherein one recess of the first set of recesses and one recess of the second set of recesses are located between each circumferentially adjacent pair of the uninterrupted radial webs.

8. The suspension bearing unit according to claim 5,
wherein exactly one recess of the first set of recesses and exactly one recess of the second set of recesses are located between each circumferentially adjacent pair of the uninterrupted radial webs.

9. The suspension bearing unit according to claim 5,
wherein the recesses of the first and second sets of recesses are triangular.

10. The suspension bearing unit according to claim 5,
wherein each of the recesses of the second set of recesses is larger than each of the recesses of the first set of recesses.

11. The suspension bearing unit according to claim 5,
wherein the recesses of the first set of recesses form a first circumferentially regularly repeated pattern, and
wherein the recesses of the second set of recesses form a second circumferentially regularly repeated pattern.

12. The suspension bearing unit according to claim 5,
including an elastomeric shock-absorbing element overmolded on the cap such that portions of the shock-absorbing element extend into the recesses of the first set of recesses and into the recesses of the second set of recesses.
